(19) United States
(12) Patent Application Publication
(10) Pub. No.: US 2020/0369117 A1
(43) Pub. Date: Nov. 26, 2020

(54) METHOD AND APPARATUS FOR CONTROLLING HEAT TRANSFER TO A TRANSPARENT SHEET

(71) Applicant: GM GLOBAL TECHNOLOGY OPERATIONS LLC, Detroit, MI (US)

(72) Inventors: David G. Meller, Shelby Township, MI (US); Todd J. Gordon, Royal Oak, MI (US)

(73) Assignee: GM GLOBAL TECHNOLOGY OPERATIONS LLC, Detroit, MI (US)

(21) Appl. No.: 16/418,146

(22) Filed: May 21, 2019

(51) Int. Cl. B60H 1/00; F25B 47/02

(52) U.S. Cl. CPC B60H 1/00735; B60S 1/026; F25B 47/02

(57) ABSTRACT

A transparent sheet is provided, and includes a heatable element arranged to transfer heat energy to the transparent sheet, a strain gage transducer disposed on the transparent sheet, and a temperature sensor disposed on the transparent sheet. A controller is in communication with the strain gage transducer and the temperature sensor, and is operably connected to the heatable element. The controller is operative to control the heatable element based upon signal inputs from the strain gage and the temperature sensor.

### INTRODUCTION

Vehicles have transparent surfaces in the form of windshields, rear windows, side windows, etc., which enable operators and passengers to view the outside world. Such transparent surfaces may be fabricated from materials such as tempered glass, laminated glass, or glass-plastic glazing. Cold, inclement weather, and humidity may reduce visibility through the vehicle windows, and on-vehicle systems are employed to effect defogging and de-icing. Electric and hybrid vehicles may employ electrical heating devices for screen defogging and de-icing, which consume electric energy. Glass expands when heat is applied, which may induce thermal stress that may lead to material fracture. There is a need to more rapidly and effectively defog and/or de-ice vehicle windows in a manner that minimizes heat-induced stress.

### SUMMARY

As described herein, a transparent sheet is provided, and includes a heatable element arranged to transfer heat energy to the transparent sheet, a strain gage transducer disposed on the transparent sheet, and a temperature sensor disposed on the transparent sheet. A controller is in communication with the strain gage transducer and the temperature sensor, and is operably connected to the heatable element. The controller is operative to control the heatable element based upon signal inputs from the strain gage and the temperature sensor.

An aspect of the disclosure includes the strain gage transducer being disposed on an inner surface of the transparent sheet.

Another aspect of the disclosure includes the transparent sheet being a multi-layer transparent sheet including a plurality of laminate sheets, and wherein the strain gage transducer is interposed between the laminate sheets.

Another aspect of the disclosure includes the strain gage transducer being a metal foil transducer.

Another aspect of the disclosure includes strain gage transducer being a piezo-resistive transducer.

Another aspect of the disclosure includes the strain gage transducer being disposed on the transparent sheet at a location that is associated with high stress induced by heat that is generated by the heatable element.

Another aspect of the disclosure includes the heatable element being a resistive wire element disposed on the transparent sheet.

Another aspect of the disclosure includes the heatable element being a heat transfer element and fan that are disposed proximal to the transparent sheet.

Another aspect of the disclosure includes the heatable element being one of a sputtered silver coating, sputtered silver on a polyester (PET) film, a silver screen-printing, an Indium-doped Tin Oxide (ITO) coating, and a Fluorine-doped Tin Oxide (FTO) coating disposed on the transparent sheet.

Another aspect of the disclosure includes the controller being operative to maximize heat output from the heatable element when the temperature indicated by the temperature sensor is less than a maximum temperature threshold.

Another aspect of the disclosure includes the controller being operative to delimit the heatable element when the signal input from the strain gage indicates that stress on the transparent sheet is greater than a threshold.

Another aspect of the disclosure includes a transparent sheet, a load sensor arranged to monitor the transparent sheet, a temperature sensor arranged to monitor the transparent sheet, a heat source arranged to transfer heat energy to the transparent sheet, and a controller, in communication with the load sensor and the temperature sensor, and operably connected to the heat source. The controller is operative to control the heat source in response to inputs from the load sensor and the temperature sensor.

Another aspect of the disclosure includes the load sensor being arranged to monitor the one of the laminate sheets at a location associated with high stress induced by heat energy from the heat source.

Another aspect of the disclosure includes the heat source a resistive wire element that is disposed on the transparent sheet.

Another aspect of the disclosure includes the heat source being a heat transfer element and fan that are disposed proximal to the transparent sheet.

Another aspect of the disclosure includes the controller being operative to maximize heat output from the heat source when the temperature indicated by the temperature sensor is less than a threshold temperature.

Another aspect of the disclosure includes the controller being operative to delimit the heat source when the signal input from the load sensor indicates that stress on the transparent glass sheet is greater than a threshold.

Another aspect of the disclosure includes the controller being operative to deactivate the heat source when the signal input from the load sensor indicates that stress on the transparent glass sheet is greater than a threshold.

Another aspect of the disclosure includes a device including a transparent sheet, a strain gage transducer arranged to monitor the transparent sheet, a heat source arranged to transfer heat energy to the transparent sheet and a controller in communication with the strain gage transducer and operably connected to the heat source, wherein the controller is operative to control heat transfer to the transparent sheet via the heat source based upon a signal input from the strain gage.

Another aspect of the disclosure includes the strain gage transducer being disposed on the transparent sheet at a location associated with high stress induced by heat energy from the heat source.

Another aspect of the disclosure includes the controller being operative to delimit the heat source when the signal input from the strain gage indicates that stress on the transparent sheet has exceeded a threshold.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a plan view of a transparent sheet and an associated heat energy control system, in accordance with the disclosure.

FIG. 2 graphically shows data associated with operating an embodiment of the heatable element to defrost a window, with the results including an amount of time necessary to effect defrost of the window in relation to applied heat flux, or watt density, in accordance with the disclosure.

FIG. 3 pictorially depicts temperatures on a surface of an example transparent sheet, in accordance with the disclosure.

FIG. 4 schematically shows a partial cut-away sectional view of the transparent sheet and associated heat energy control system shown with reference to FIG. 1, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity, spatial and directional terms such as top, bottom, left, right, up, over, above, below, beneath, rear, front, inner, and outer may be used with respect to the drawings. These and similar directional terms are not to be construed to limit the scope of the disclosure. Furthermore, the disclosure, as illustrated and described herein, may be practiced in the absence of an element that is not specifically disclosed herein.

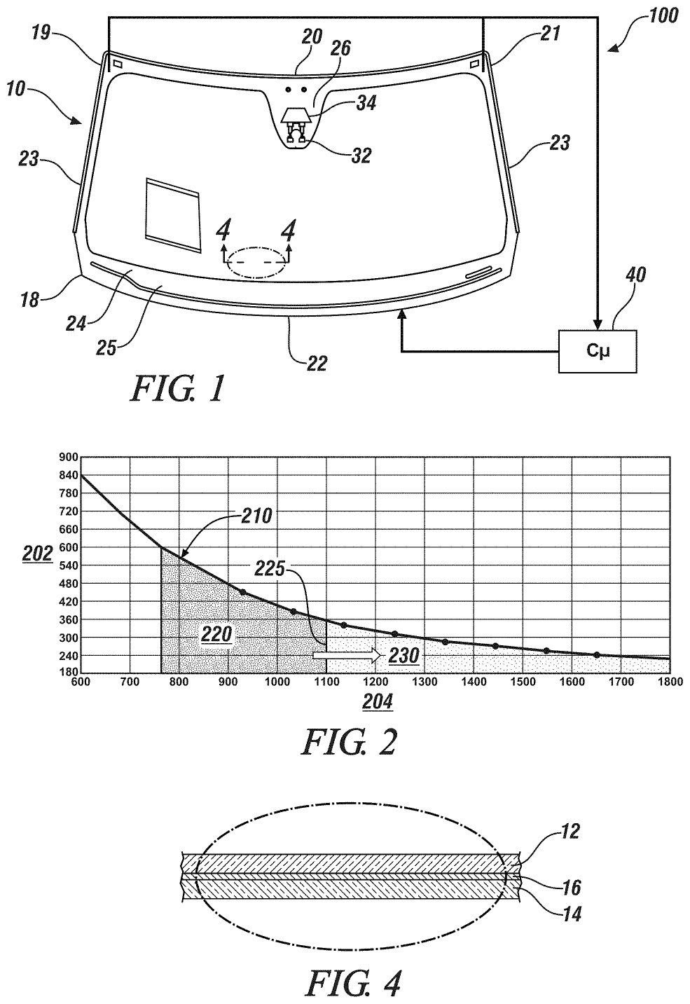

Referring to the drawings, wherein like reference numerals correspond to like or similar components throughout the several Figures, FIGS. 1 and 4, consistent with embodiments disclosed herein, illustrate a top plan view and partial cutaway sectional view of an embodiment of a control system 100 for a heatable transparent sheet 10 in accordance with the disclosure. The concepts are described, in one non-limiting example, in the form of a windshield 10 for a vehicle in one embodiment, although the concepts described herein are not so limited. The control system 100 and transparent sheet 10 may be advantageously employed on an application that employs transparent sheets, i.e., windows, and may include a windshield, a rear window, side windows, roof screens, etc. on a vehicle. The control system 100 and transparent sheet 10 may further be advantageously employed on structures, such as external sheets for buildings. When employed on-vehicle, the vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The heatable transparent sheet 10 may be a single layer transparent planar sheet in one embodiment. Alternatively, the transparent sheet 10 may be a multi-layer transparent planar sheet that is composed as laminate sheets that include a first, inner glass sheet 12 that is secured to a second, outer glass sheet 14 by an intermediate sheet 16 that is interposed therebetween. The first and second glass sheets 12, 14 may be composed of clear chemically strengthened glass sheets that are heat strengthened or heat tempered glass sheets, Plexiglas, or other materials, and may be annealed in a laminate construction. The intermediate sheet 16 may be vinyl, or another material. Furthermore, the embodiment of the transparent sheet 10 being a multi-layer transparent sheet is described as having two layers of glass, but the concepts described herein are not so limited, and other embodiments may include three, four, or more glass sheets with interposed intermediate sheets. Furthermore, the transparent sheet 10 is described as being a planar sheet. It is appreciated that the planar sheet may be formed to have a curved planar geometry, such as when employed as a windshield or a rear window, or may be a flat planar sheet.

The transparent sheet 10 includes an outer periphery 18 that includes an upper-left corner 19, an upper-center portion 20, an upper right-corner 21, a bottom portion 22, and side portions 23. In one embodiment, and as shown, a peripheral mask 24 is disposed on the inner glass sheet 12 around the periphery 18 and, and includes an upper-center mask 26 that is disposed on the upper center portion 20. In one embodiment, a heat source in the form of a controllable heatable element 25 is disposed on the inner glass sheet 12 around at least a portion of the periphery 18, and is covered by the peripheral mask 24. The heatable element 25 is arranged to transfer heat energy to the transparent sheet 10. The heatable element 25 is advantageously employed to prevent formation of fog, snow and/or ice on, to melt snow and ice on, and/or to remove fog, snow and ice from, the outer surface of a glass sheet, e.g., the external surface of the transparent sheet 10. In one embodiment, the heatable element 25 is arranged as a controllable, electrically-powered heating element, and may be an electrically-powered conductive heatable element capable of conductively transferring heat to a surface of a sheet. By way of non-limiting examples, the heatable element 25 may be a resistive wire, a plurality of resistive wires, a conductive coating, a conductive film, etc. Non-limiting examples of the heatable element 25 include the heatable element being composed as one of a sputtered silver coating, sputtered silver disposed on a polyester (PET) film, a silver screen-printing, an Indium-doped Tin Oxide (ITO) coating, and a Fluorine-doped Tin Oxide (FTO) coating. Alternatively or in addition, the heatable element 25 may be in the form of a separate, remote heat source and associated fan that are disposed in an interior portion of the vehicle to controllably convectively transfer heat to the transparent sheet 10. When the transparent sheet 10 is employed on-vehicle, the purpose of operating the heatable element 25 is to rapidly provide heating to the affected area in order to improve visibility and thus enable use of the vehicle.

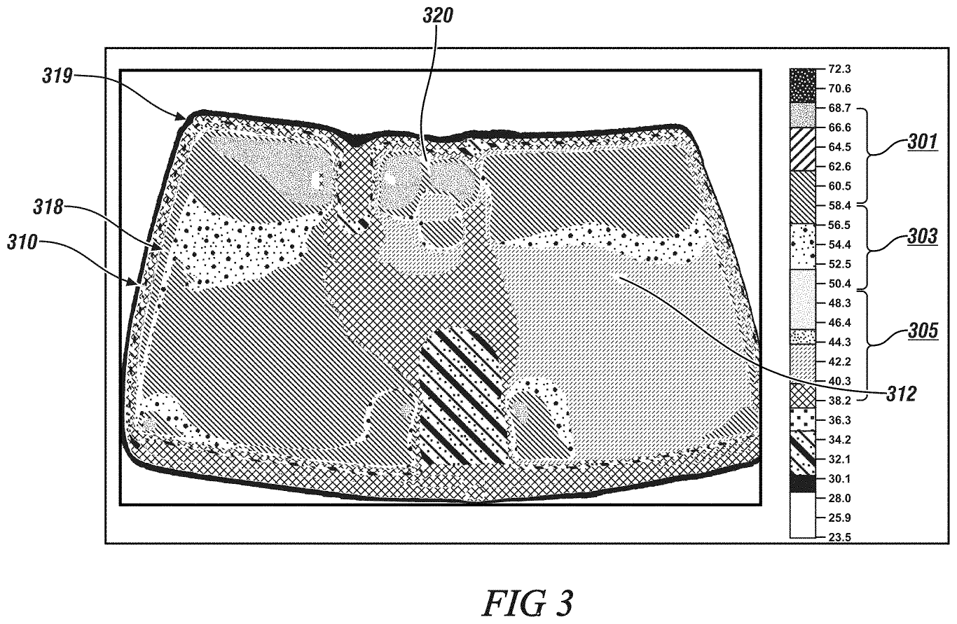

FIG. 2 graphically shows data associated with operating an embodiment of the heatable element 25 to defrost a window, with the results including a requisite amount of time to effect defrost of the window in relation to applied heat flux, or watt density. Time to defrost is indicated on the vertical axis 202, and watt density is indicated on the horizontal axis 204. The heatable element 25 may be characterized in terms of generated watt density (W/m²) of the surface area of the heatable element 25. As indicated with reference to line 210, the watt density of the heatable element 25 is inversely proportional to a required operating time of the heatable element 25 to effect a result, such as de-icing or defrosting the affected window. A first area 220 indicates a time/watt density relationship that reflects a present state of the art operation of an example heatable element on-vehicle, with the watt-density presently limited to a maximum value, as indicated by line 225. A second area 230 indicates a time/watt density relationship that reflects an achievable operation of an example heatable element on-vehicle employing the concepts described with reference to FIGS. 1 and 3. As indicated, an increase in the applied heat flux, or watt density serves to reduce the time to defrost a windshield or another window.

Referring again to FIG. 1, a load sensor 34, in the form of one or a plurality of strain gage transducers, is arranged to monitor induced stress in the transparent sheet 10. The load sensor 34 may be advantageously employed to monitor heat-induced stress caused by the heatable element 25. The load sensor 34 may be a strain gage transducer that may be disposed on and operatively coupled to a surface of the transparent sheet 10. The strain gage transducer may be characterized by a repeatable, measurable electrical resistance that changes in response to mechanical deformation that is caused by an induced load, stress, tension, etc., including conditions in which the induced stress is caused by a change in material temperature. A strain gage transducer may be a metallic foil device, a piezo-resistive/ceramic device, or another device that may be characterized by a measurable electrical resistance that changes in response to induced load, stress, tension, etc. A single load sensor 34, or a plurality of load sensors 34, may be deployed on the transparent sheet 10. In one embodiment, the load sensor 34 is configured as a plurality of strain gage transducers that are arranged in an orthogonal array in a manner to effect strain monitoring in two or more axes that are defined by the planar transparent sheet 10.

The load sensor 34 may be fixedly adhered to an inner surface of the transparent sheet 10 via chemical bonding, or another adhesion mechanism, in one embodiment. Alternatively, when the transparent sheet 10 is a multi-layer sheet, the load sensor 34 may be interposed between the inner glass sheet 12 and the outer glass sheet 14, and adhered thereto via chemical bonding or another adhesion mechanism, in one embodiment. The load sensor 34 may be disposed on the transparent sheet 10 at a location that is associated with high induced stress caused by transferred heat energy from the heatable element 25. In one embodiment, a plurality of the load sensors 34 may be disposed on the transparent sheet 10 at various locations.

Referring now to FIG. 3, a pictorial depiction indicating temperatures on a surface of an example transparent sheet 310 is provided, wherein the temperatures are captured during activation of a heatable element (not shown) under predetermined ambient conditions. The temperatures as shown include a lower temperature area 301 in a center portion 312 of the transparent sheet 310, median temperature areas 303 near an outer periphery 318, and higher temperature areas 305 near the upper portion 319, particularly near the upper center portion 320. As appreciated by those skilled in the art, temperature-induced stress in the transparent sheet 310 increases with increased temperature of the transparent sheet 310. Thus, the higher temperature areas 305 correlate to higher induced stress areas. Therefore, the upper center portion 320 may indicate one desirable location for placement of an embodiment of the load sensor 34 described with reference to FIG. 1 in order to monitor maximum induced stress in the transparent sheet 310.

Referring again to FIG. 1, a temperature sensor 32 may be disposed on the transparent sheet 10 proximal to the load sensor 34. The load sensor 34 and the temperature sensor 32 are in communication with a controller 40. The controller 40 also operatively connects to the heatable element 25. The controller 40 includes executable code in the form of a closed-loop control routine that dynamically controls activation time of the heatable element 25 based upon measurements derived from the load sensor 34 and/or the temperature sensor 32 in a manner that maximizes electric power to the heatable element 25 during operation below thresholds, thus minimizing time required to effect defogging or deicing of the transparent sheet 10. The controller 40 monitors the inputs from the load sensor 34 and the temperature sensor 32, and limits or deactivates the heatable element 25 when the load sensor 34 indicates that the induced stress caused by heating the transparent sheet 10 is greater than a stress threshold, or when the temperature sensor 32 indicates that the caused by heating the transparent sheet 10 is greater than a temperature threshold. The stress threshold and the temperature threshold may be application-specific calibrated parameters.

In this manner, the controller 40 actively monitors critical hot-spots in the transparent sheet 10 employing temperature sensors and strain gage transducers, and manages control parameters associated with the heatable element 25 to ensure the system operates within parameters. Such active control facilitates use of increased power for heating under certain circumstances to reduce deice/defog times, without inducing excessive stress in the transparent sheet 10. Such operation may also be employed to prevent heat activation of transparent sheets whose structural integrity has been compromised. Furthermore, the operation of the controller 40 to actively monitor critical hot-spots in the transparent sheet 10 employing temperature sensors and strain gage transducers, and managing control parameters associated with the heatable element 25 to ensure the system operates within parameters may facilitate implementation of embodiments of the heatable element 25 that include sputtered silver coating, sputtered silver disposed on a polyester (PET) film, silver screen-printing, Indium-doped Tin Oxide (ITO) coating, and Fluorine-doped Tin Oxide (FTO) coating.

The term “controller” and related terms such as control module, module, control, control unit, processor and similar terms refer to one or various combinations of Application Specific Integrated Circuit(s) (ASIC), Field-Programmable Gate Arra (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that compares an actual or standard measurement associated with a device or system with a perceived or observed measurement or a commanded position for the device or system. A calibration as described herein can be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, the present disclosure may take the form of a computer program product embodied in a tangible medium of expression having computer-usable program code embodied in the medium.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A device, comprising:
a transparent sheet;
a strain gage transducer disposed on the transparent sheet;
a temperature sensor disposed on the transparent sheet;
a heatable element disposed on the transparent sheet;
a controller, in communication with the strain gage transducer and the temperature sensor, and operably connected to the heatable element;
the controller operative to control the heatable element based upon signal inputs from the strain gage transducer and the temperature sensor.

2. The device of claim 1, wherein the strain gage transducer is disposed on an inner surface of the transparent sheet.

3. The device of claim 1, wherein the transparent sheet comprises a multi-layer transparent sheet including a plurality of laminate sheets, and wherein the strain gage transducer is interposed between the laminate sheets.

4. The device of claim 1, wherein the strain gage transducer comprises a metal foil transducer.

5. The device of claim 1, wherein the strain gage transducer comprises a piezo-resistive transducer.

6. The device of claim 1, wherein the strain gage transducer is disposed on the transparent sheet at a location that is associated with stress induced by heat that is generated by the heatable element.

7. The device of claim 1, wherein the heatable element comprises a resistive wire element disposed on the transparent sheet.

8. The device of claim 1, wherein the heatable element comprises one of a sputtered silver coating, sputtered silver on a polyester (PET) film, a silver screen-printing, an Indium-doped Tin Oxide (ITO) coating, and a Fluorine-doped Tin Oxide (FTO) coating disposed on the transparent sheet.

9. The device of claim 1, wherein the heatable element comprises a heat transfer element and fan that are disposed proximal to the transparent sheet.

10. The device of claim 1, wherein the controller operative to control the heatable element based upon signal inputs from the strain gage transducer and the temperature sensor comprises the controller operative to maximize heat output from the heatable element when the temperature indicated by the temperature sensor is less than a maximum temperature threshold.

11. The device of claim 1, wherein the controller operative to control the heatable element based upon signal inputs from the strain gage transducer and the temperature sensor comprises the controller operative to delimit the heatable element when the signal input from the strain gage indicates that stress on the transparent sheet is greater than a threshold.

12. A control system for a heatable transparent sheet, comprising:
a transparent sheet;
a load sensor arranged to monitor the transparent sheet;
a temperature sensor arranged to monitor the transparent sheet;
a heat source arranged to transfer heat energy to the transparent sheet; and
a controller, in communication with the load sensor and the temperature sensor, and operably connected to the heat source;
wherein the controller is operative to control the heat source in response to inputs from the load sensor and the temperature sensor.

13. The control system of claim 12, wherein the load sensor is arranged to monitor the transparent sheet at a location associated with high stress induced by heat energy from the heat source.

14. The control system of claim 12, wherein the heat source comprises a resistive wire element disposed on the transparent sheet.

15. The control system of claim 12, wherein the heat source comprises one of a sputtered silver coating, sputtered silver on a polyester (PET) film, a silver screen-printing, an Indium-doped Tin Oxide (ITO) coating, and a Fluorine-doped Tin Oxide (FTO) coating disposed on the transparent sheet.

16. The control system of claim 12, wherein the controller operative to control the heat source based upon signal inputs from the load sensor and the temperature sensor comprises the controller operative to maximize heat output from the heat source when the temperature indicated by the temperature sensor is less than a threshold temperature.

17. The control system of claim 12, wherein the controller operative to control the heat source based upon signal inputs from the load sensor and the temperature sensor comprises the controller operative to delimit the heat source when the signal input from the load sensor indicates that stress on the transparent sheet is greater than a threshold.

18. The control system of claim 12, wherein the controller operative to control the heat source based upon signal inputs from the load sensor and the temperature sensor comprises the controller operative to deactivate the heat source when the signal input from the load sensor indicates that stress on the transparent sheet is greater than a threshold.

19. A device, comprising:
a transparent sheet;
a strain gage transducer arranged to monitor the transparent sheet;
a heat source arranged to transfer heat energy to the transparent sheet; and
a controller, in communication with the strain gage transducer and operably connected to the heatable source;
wherein the controller is operative to control heat transfer to the transparent sheet via the heat source based upon a signal input from the strain gage.

20. The device of claim 19, wherein the strain gage transducer is disposed on the transparent sheet at a location associated with stress induced by heat energy from the heat source, and wherein the controller operative to control heat transfer to the transparent sheet via the heat source based upon the signal input from the strain gage comprises the controller operative to delimit the heat source when the signal input from the strain gage indicates that stress on the transparent sheet has exceeded a threshold.
